(19) United States
(12) Patent Application Publication
(10) Pub. No.: US 2024/0377647 A1
(43) Pub. Date: Nov. 14, 2024

(54) OPTICAL ASSEMBLY TRACKING

(71) Applicant: Apple Inc., Cupertino, CA (US)

(72) Inventors: Matin SEADAT BEHESHTI, Sunnyvale, CA (US); Jia TAO, San Jose, CA (US); Aidan N. ZIMMERMAN, Sunnyvale, CA (US); John S. CAMP, Los Gatos, CA (US); David R. CRAMER, Los Gatos, CA (US); Evan D. CHRISTENSEN, Campbell, CA (US); Ivan S. MARIC, San Francisco, CA (US); Kristina A. BABIARZ, San Jose, CA (US); Jeremy C. FRANKLIN, San Francisco, CA (US)

(21) Appl. No.: 18/692,788

(22) PCT Filed: Sep. 8, 2022
(86) PCT No.: PCT/US2022/042954

§ 371 Date: Mar. 15, 2024

Related U.S. Application Data
(60) Provisional application No. 63/247,632, filed on Sep. 23, 2021.

(51) Int. Cl. G02B 27/01; G01D 5/347

(52) U.S. Cl. CPC G02B 27/0176; G01D 5/34715; G01D 5/3473; G02B 27/0179; G02B 2027/0154; G02B 2027/0187

(57) ABSTRACT

A wearable electronic device can include an optical assembly that supports a display and is moveable within the wearable electronic device. A compliant tracking assembly can be provided to facilitate precision alignment to allow the tracking assembly to operate as an encoder system. For example, the sensor of the tracking assembly can be consistently aligned with a scale so that movement of the optical assembly relative to the chassis can be tracked and controlled accurately and precisely. Such a compliant mechanism can provide protection of the sensor throughout the life of the wearable electronic device.

### CROSS-REFERENCE TO RELATED APPLICATION

This application claims the benefit of U.S. Provisional Application No. 63/247, 632, entitled “HEAD-MOUNTABLE DEVICE WITH OPTICAL MODULE TRACKING,” filed Sep. 23, 2021, the entirety of which is incorporated herein by reference.

### TECHNICAL FIELD

The present description relates generally to head-mountable devices, and, more particularly, to head-mountable devices with optical assembly tracking.

### BACKGROUND

A head-mountable device can be worn by a user to display visual information within the field of view of the user. The head-mountable device can be used as a virtual reality (VR) system, an augmented reality (AR) system, and/or a mixed reality (MR) system. A user may observe outputs provided by the head-mountable device, such as visual information provided on a display. The display can optionally allow a user to observe an environment outside of the head-mountable device. Other outputs provided by the head-mountable device can include speaker output and/or haptic feedback. A user may further interact with the head-mountable device by providing inputs for processing by one or more components of the head-mountable device. For example, the user can provide tactile inputs, voice commands, and other inputs while the device is mounted to the user's head.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates a top view of a head-mountable device, according to some embodiments of the present disclosure.

FIG. 2 illustrates a rear view of the head-mountable device of FIG. 1, according to some embodiments of the present disclosure.

FIG. 3 illustrates a perspective view of an optical assembly of the head-mountable device of FIGS. 1 and 2 and a tracking assembly, according to some embodiments of the present disclosure.

FIG. 4 illustrates a perspective view of a tracking assembly, according to some embodiments of the present disclosure.

FIG. 5 illustrates a top view of a tracking assembly having a sensor and a scale, according to some embodiments of the present disclosure.

FIG. 6 illustrates a top view of a head-mountable device, according to some embodiments of the present disclosure.

FIG. 7 illustrates a top view of a head-mountable device, according to some embodiments of the present disclosure.

FIG. 8 illustrates a side sectional view of a portion of a head-mountable device, according to some embodiments of the present disclosure.

FIG. 9 illustrates another side sectional view of the portion of the head-mountable device of FIG. 8, according to some embodiments of the present disclosure.

FIG. 10 illustrates a block diagram of a head-mountable device, in accordance with some embodiments of the present disclosure.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

Head-mountable devices, such as head-mountable displays, headsets, visors, smartglasses, head-up display, etc., can perform a range of functions that are managed by the components (e.g., sensors, circuitry, and other hardware) included with the wearable device.

Many of the functions performed by a head-mountable device are optimally experienced when the output is tailored to the needs of the user wearing the head-mountable device. In particular, the visual output features of a head-mountable device can be provided in a manner that accommodates a user's vision, including optimal position and/or orientation based on the eyes of the user. For example, a head-mountable device can detect the eyes of the user and adjust the position and/or orientation of one or more displays to accommodate the user's eyes. Such adjustments can be facilitated by an optical enclosure that is controllably moved to carry the display to the desired position and/or orientation. Accordingly, any given user can properly view the visual output features when using the head-mountable device.

A variety of sensors can be provided to detect translation, rotation, or other types of movement of the optical assemblies and/or other components of the head-mountable device. These sensors may operate most optimally when installed and aligned with high precision and accuracy. Such sensors may also benefit from protection throughout life of the product to continue to function while being protected against external elements such as temperature, drop/impact loads, pressure/squeeze loads, and the like.

Embodiments of the present disclosure provide an optical assembly that supports a display and is moveable within the head-mountable device. A compliant tracking assembly can be provided to facilitate precision alignment to allow the tracking assembly to operate as an encoder system. For example, the sensor of the tracking assembly can be consistently aligned with a scale so that movement of the optical assembly relative to the chassis can be tracked and controlled accurately and precisely. Such a compliant mechanism can provide protection of the sensor throughout the life of the head-mountable device.

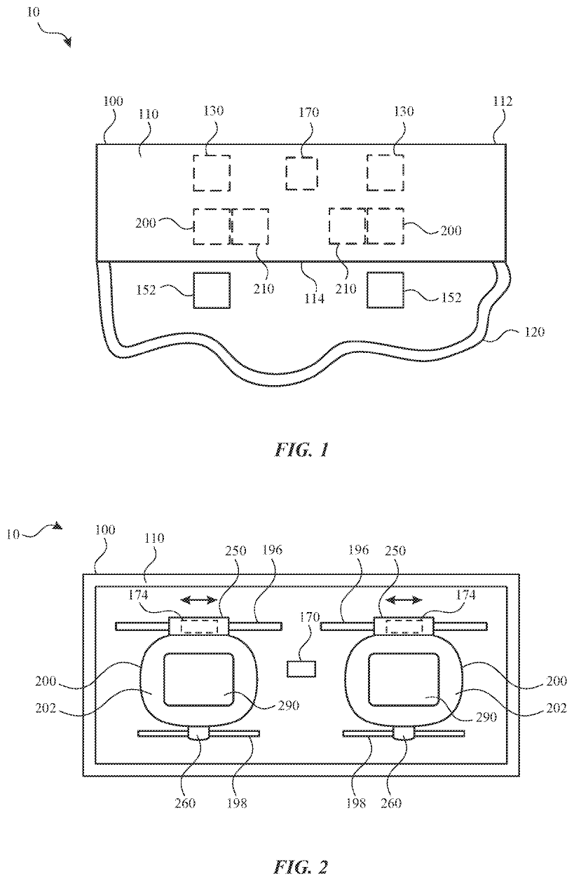

These and other embodiments are discussed below with reference to FIGS. 1-8. However, those skilled in the art will readily appreciate that the detailed description given herein with respect to these Figures is for explanatory purposes only and should not be construed as limiting.

According to some embodiments, for example as shown in FIG. 1, a head-mountable device 10 includes a chassis 110 that is worn on a head of a user. The chassis 110 can be positioned in front of the eyes of a user to provide information within a field of view of the user. The chassis 110 can provide nose pads or another feature to rest on a user's nose and/or engage other parts of the user's face.

The chassis 110 can be supported on a user's head with the engager 120. The engager 120 can wrap or extend along opposing sides of a user's head. The engager 120 can optionally include earpieces for wrapping around or otherwise engaging or resting on a user's ears. It will be appreciated that other configurations can be applied for securing the head-mountable device 10 to a user's head. For example, one or more bands, straps, belts, caps, hats, or other components can be used in addition to or in place of the illustrated components of the head-mountable device 10. By further example, the engager 120 can include multiple components to engage a user's head.

The chassis 110 can provide structure around a peripheral region thereof to support any internal components of the head-mountable device 10 in their assembled position. For example, the chassis 110 can enclose and support various internal components (including for example integrated circuit chips, processors, memory devices and other circuitry) to provide computing and functional operations for the head-mountable device 10, as discussed further herein. While several components are shown within the chassis 110, it will be understood that some or all of these components can be located anywhere within or on the head-mountable device 10. For example, one or more of these components can be positioned within the engager 120 of the head-mountable device 10.

The chassis 110 can include and/or support one or more cameras 130. The cameras 130 can be positioned on or near an outer side 112 of the chassis 110 to capture images of views external to the head-mountable device 10. As used herein, an outer side of a portion of a head-mountable device is a side that faces away from the user and/or towards an external environment. The captured images can be used for display to the user or stored for any other purpose. Each of the cameras 130 can be movable along the outer side 112. For example, a track or other guide can be provided for facilitating movement of the camera 130 therein.

The head-mountable device 10 can include optical assemblies 200 that provide visual output for viewing by a user wearing the head-mountable device 10. One or more optical assemblies 200 can be positioned on or near an inner side 114 of the chassis 110. As used herein, an inner side 114 of a portion of a head-mountable device is a side that faces toward the user and/or away from the external environment.

An optical assembly 200 can transmit light from a physical environment (e.g., as captured by a camera) for viewing by the user. Such an optical assembly 200 can include optical properties, such as lenses for vision correction based on incoming light from the physical environment. Additionally or alternatively, an optical assembly 200 can provide information with a display 290 within a field of view of the user. Such information can be provided to the exclusion of a view of a physical environment or in addition to (e.g., overlaid with) a physical environment.

A physical environment refers to a physical world that people can interact with and/or sense without necessarily requiring the aid of an electronic device. A computer-generated reality environment relates to a partially or wholly simulated environment that people sense and/or interact with the assistance of an electronic device. Examples of computer-generated reality include, but are not limited to, mixed reality and virtual reality. Examples of mixed realities can include augmented reality and augmented virtuality. Examples of electronic devices that enable a person to sense and/or interact with various computer-generated reality environments include head-mountable devices, projection-based devices, heads-up displays (HUDs), vehicle windshields having integrated display capability, windows having integrated display capability, displays formed as lenses designed to be placed on a person's eyes (e.g., similar to contact lenses), headphones/earphones, speaker arrays, input devices (e.g., wearable or handheld controllers with or without haptic feedback), smartphones, tablets, and desktop/laptop computers. A head-mountable device can have an integrated opaque display, have a transparent or translucent display, or be configured to accept an external opaque display from another device (e.g., smartphone).

Referring again to FIG. 1, the head-mountable device can include one or more lens assemblies 152. The lens assembly 152 can be or include one or more lens elements for providing corrective vision capabilities. It will be understood that, where multiple lenses are used, the lens elements of the lens assembly 152 can be provided together or separately (e.g., for combination). One lens assembly 152 can be applied to each of multiple (e.g., two) optical assemblies 200, as described further herein.

Movement of the optical assemblies 200 with respect to the chassis 110 can be tracked with corresponding tracking assemblys 210. A tracking assembly 210 can be provided between each optical assembly 200 and the chassis 110 to detect relative motion there between. The tracking assembly 210 can include a sensor that interacts with a scale, as described further herein.

Referring now to FIG. 2, the optical assemblies of the head-mountable device can be adjustable to accommodate the facial features of the user wearing the head-mountable device and align each optical assembly with a corresponding eye of the user.

As shown in FIG. 2, each optical assembly 200 can include an optical enclosure 202 and a display 290. The display 290 can be supported by the optical enclosure 202, such that movement (e.g., adjustments to position and/or orientation) of the optical enclosure 202 results and corresponding movement of the display 290.

As further shown in FIG. 2, the head-mountable device 10 can include one or more sensors, such as user sensors 170. The user sensor 170 can be positioned and arranged to detect a characteristic of the user, such as facial features. For example, such a user sensor can perform facial feature detection, facial movement detection, facial recognition, eye tracking, user mood detection, user emotion detection, voice detection, and the like. While only one user sensor 170 is depicted in FIG. 2, it will be understood that any number of user sensors 170 can be provided. For example, a user sensor 170 can be coupled to, included with, or part of an optical assembly 200. Accordingly, such a user sensor 170 can be an eye sensor that moves with the optical assembly 200 and is operated to detect the presence or absence of an eye (e.g., pupil, etc.) of a user, as well as the position and/or orientation thereof with respect to the head-mountable device 10. Such detections can further be used to determine whether the display 290 is in an optimal position and/or orientation with respect to the eye of the user and/or whether adjustments to the optical assembly 200 would be appropriate.

Each optical assembly 200 can be adjusted to align with a corresponding eye of the user. For example, each optical assembly 200 can be moved along and/or about one or more axes until a center of each optical assembly 200 is aligned with a center of the corresponding eye. Accordingly, the distance between the optical assemblies 200 can be set based on an interpupillary distance (“IPD”) of the user. IPD is defined as the distance between the centers of the pupils of a user's eyes. While translational movement is depicted in FIG. 2, it will be further understood that rotational movement can, additionally or alternatively, be facilitated with respect to the chassis 110.

The pair of optical assemblies 200 can be mounted to the chassis 110 and separated by a distance. The distance between the pair of optical assemblies 200 can be designed to correspond to the IPD of a user. The distance can be adjustable to account for different IPDs of different users that may wear the head-mountable device 10. For example, either or both of the optical assemblies 200 may be movably mounted to the chassis 110 to permit the optical assemblies 200 to move or translate laterally to make the distance larger or smaller. Any type of manual or automatic mechanism may be used to permit the distance between the optical assemblies 200 to be an adjustable distance. For example, the optical assemblies 200 can be mounted to the chassis 110 via slidable tracks or guides that permit manual or electronically actuated movement of one or more of the optical assemblies 200 to adjust the distance there between. By further example, the optical enclosures 202 can each include one or more hangers that interact with guide rods of the head-mountable device 10 to facilitate movement. By further example, an upper hanger 250 can facilitate movement of the optical assembly 200 by sliding along an upper guide rod 196 disposed on the chassis 110, and/or a lower hanger 260 can facilitate movement of the optical assembly 200 by sliding along a lower guide rod 198 disposed on the chassis 110. One or more actuators 174 can be operated to effect movement of the optical assembly 200 with respect to the chassis 110. The actuators 174 can operate independently to move each of the optical assemblies 200. Additionally or alternatively, a single actuator 174 can be operated to simultaneously move each of the optical assemblies 200, for example with opposite but symmetrical movement.

Additionally or alternatively, the optical assemblies 200 can each be moved to a target location based on a desired visual effect that corresponds to user's perception of the optical assembly 200 when it is positioned at the target location. The target location can be determined based on a focal length of the user and/or optical elements of the system. For example, the user's eye and/or optical elements of the system can determine how the visual output of the optical assembly 200 will be perceived by the user. The distance between the optical assembly 200 and the user's eye and/or the distance between the optical assembly 200 and one or more optical elements can be altered to place the optical assembly 200 at, within, or outside of a corresponding focal distance. Such adjustments can be useful to accommodate a particular user's eye, corrective lenses, and/or a desired optical effect.

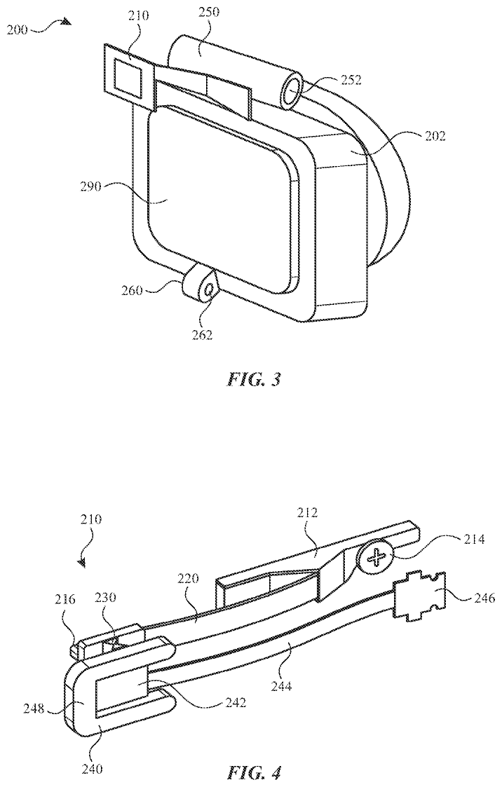

Referring now to FIG. 3, an optical assembly can include or interact with a tracking assembly to monitor and guide movement of the optical device. FIG. 3 illustrates a perspective view of an optical assembly. As shown in FIG. 3, each optical assembly 200 can include a display 290 within, coupled to, and/or adjacent to an optical enclosure 202. The optical enclosure 202 can surround an outer periphery of the display 290 and/or an output portion thereof and provide support thereto. Additionally, the optical enclosure 202 can define at least a portion of a periphery of the optical assembly 200.

The display 290 of the optical assembly 200 can be operated to display visual information for a user. For example, the display 290 can provide visual (e.g., image or video) output by utilizing, for example, digital light projection, OLEDs, LEDs, uLEDs, liquid crystal on silicon, laser scanning light source, or any combination of these technologies. In the illustrated example of FIG. 3, a rear side of the display 290 is shown, where in the display 290 can output light and/or visual features on an opposing side of the optical enclosure 202.

The optical enclosure 202 can further include an upper hanger 250. The upper hanger 250 can include a hanger channel 252 for receiving a guide rod. The optical enclosure 202 can further include a lower hanger 260. The lower hanger 260 can include a hanger channel 262 for receiving a guide rod. The upper hanger 250 and the lower hanger 260 can facilitate movement of the optical assembly 200 by sliding along a corresponding guide rod and/or other structure. By providing a pair of hanger channels, movement of the optical assembly 200 can be limited to, for example, one axis of motion. It will be understood that additional configurations can provide a greater number and/or different degrees of freedom.

As further shown in FIG. 3, a tracking assembly 210 can be provided on a side of the optical assembly 200 to track movement of the optical assembly 200 with respect to a chassis (not shown). In some embodiments, the tracking assembly 210 can be mounted to the optical assembly 200 to move with respect to the chassis. Alternatively, in some embodiments, the tracking assembly 210 can be mounted to a chassis to detect movement of the optical assembly 200 with respect to the chassis.

While the tracking assembly 210 is shown disposed on an optical assembly 200, it will be understood that the tracking assembly 210 and a corresponding scale can be disposed on any two structures to detect relative movement there between. For example, the tracking assembly 210 and a corresponding scale can be disposed on any two of a chassis, an optical assembly, a lens assembly, and a display. By further example, the tracking assembly 210 and a corresponding scale can be disposed on any two of a chassis and a user input component (e.g., crown, slider, button, knob, key, and the like).

Referring now to FIG. 4, the tracking assembly 210 can include mechanisms that extend between a chassis and an optical assembly of a head-mountable device to detect relative movement there between. As shown in FIG. 4, the tracking assembly 210 can include a bracket 212 for engaging a supporting structure, such as a chassis or an optical assembly. For example, a fastener 214 can be provided to couple the bracket 212 to a supporting structure. It will be understood that a variety of fasteners can be provided, including pins, holes, screws, threading, magnets, adhesives, and the like. In some embodiments, the bracket 212 and/or another portion of the tracking assembly 210 is otherwise disposed on the chassis 110 or the optical assembly 200 (e.g., at the optical enclosure 202, an upper hanger 250, a lower hanger 260, or the like). In particular, the bracket 212 and/or another portion of the tracking assembly 210 need not be coupled with an intervening structure, but rather with a direct connection. For example, the bracket 212 and/or another portion of the tracking assembly 210 can be monolithically formed with at least a portion of the chassis 110 or the optical assembly 200. By further example, the bracket 212 and/or another portion of the tracking assembly 210 can be insert molded with at least a portion of the chassis 110 or the optical assembly 200. It will be understood the tracking assembly 210 can be disposed on a portion of the chassis 110 or the optical assembly 200 (e.g., at the optical enclosure 202, an upper hanger 250, a lower hanger 260, or the like), with that portion being coupled to other portions of the chassis 110 or the optical assembly 200.

As further shown in FIG. 4, a beam 220 can extend from the bracket 212. The beam 220 can be a flexible yet resilient structure that helps bias a tracking sensor 240 in a particular direction and/or against another structure. For example, the beam 220 can be of a carbon fiber and/or glass fiber composition to urge the tracking sensor 240 when it is deflected from a nominal position. By further example, the beam 220 can be of one or more of a variety of materials, such as metals, plastics, and the like. The beam 220 can be elastic to undergo a degree of flexion without plastic deformation. The beam 220 can include or interact with other biasing mechanisms, such as compression springs, torsion bars, cantilever round bar springs, torsion springs, compressive foam, cantilevered beams, cantilevered springs, and the like.

The tracking assembly 210 can further include a hinge 230 coupling the tracking sensor 240 to the beam 220. The hinge 230 can facilitate changes to the rotational orientation of the tracking sensor 240 with respect to the beam 220. As such, the hinge 230 can allow the tracking sensor 240 to conform to a surface against which it is held by a biasing force provided by the beam 220, as described further herein. The hinge 230 can optionally be a monolithic material that bends to facilitate rotation about an axis extending through the hinge 230. For example, the hinge 230 can include a polymer (e.g., rubber, plastic, Ultem, Pebax), metal, composite material, or other material that elastically deforms to facilitate such rotation of the tracking sensor 240. By further example, the hinge 230 can include a barrel hinge, a spring hinge, a pivot hinge, a living hinge, and the like. The hinge 230 can include a narrowed or tapered portion for providing a region about which pivoting can be performed. Optionally, the hinge 230 can bias the tracking sensor 240 to a nominal orientation with respect to the beam 220. In some embodiments, the hinge 230 can limit the tracking sensor 240 to a closed range of rotation.

In some embodiments, the bracket 212, the beam 220, and the hinge 230 are a monolithic structure. As used herein, a monolithic structure is one that is integrally formed of a single piece. For example, the bracket 212, the beam 220, and the hinge 230 can be of a continuous material and/or materials and/or can lack or omit joining structures between portions thereof, such as adhesives, snaps, locks, latches, fasteners, and the like. By providing a monolithic structure, such portions of the tracking assembly 210 do not contain dimensional variations that occur in assembled parts.

Accordingly, the monolithic structure can be fabricated to more precise and consistent dimensions. Additionally, the tracking assembly 210 can avoid the added weight that would be imposed by adhesives and/or other securing mechanisms between constituent parts of an assembled optical enclosure.

The tracking assembly 210 can further include a flange 216, for example at the tracking sensor 240, to interact with stoppers to limit a range of motion of the tracking sensor 240, as described further herein.

The tracking sensor 240 can include a frame 248 and a reader 242 that detects and/or otherwise interacts with a scale to operate as an encoder. For example, as shown in FIG. 4, the reader 242 can be inset within a recess of the frame 248, which can provide an engagement surface for contacting a scale. As such, the reader 242 need not be proud of the frame 248 and/or other components of the tracking sensor 240. The reader 242 can nonetheless have a fixed position with respect to other components of the tracking sensor 240, such that engagement on a scale by the outer surface of the frame 248 can maintain the reader 242 at a fixed distance away from the scale.

The tracking sensor 240 can further include a flex circuit 244 or other link for operably connecting the tracking sensor 240 to control circuitry (e.g., a processor). As used herein, “flexible circuit” or “flex circuit” is a structure that includes a conductive layer, an insulation layer, and optionally a substrate layer. A flex circuit can be provided in electrical communication with at least one electrode, terminal, and/or connector. A flex circuit is generally flexible, such that it can conform to contours of other components. The flex circuit 244 can operably connect the tracking sensor 240 to a controller of the head-mountable device. For example, the flex circuit 244 can have, at an end portion thereof, a connector 246 for providing electrical communication through the circuitry of the flex circuit 244. The flex circuit 244 can bend and/or flex to maintain an operable connection throughout a range of motion of the tracking sensor 240.

The tracking assembly 210, for example at the bracket 212, can include a compliant mechanism integrated to the enclosure of the optical assembly. For example, the compliant mechanism can be combined with a cowling to hold down board-to-board or other cable connections. The tracking assembly 210 can provide structural support for other nearby equipment hardware (e.g., PCBs, biasing springs/mechanisms, guide rod housing of the optical assembly, etc.). The tracking assembly 210 can provide protection, sealing, housing of the enclosed sensing element(s) and/or other nearby optical/sensing element(s) such as lenses, sensing elements, displays. The tracking assembly 210 can provide attachment points for nearby components such as cowlings, secondary sensors/targets, lens/display of optical assemblies, and the like.

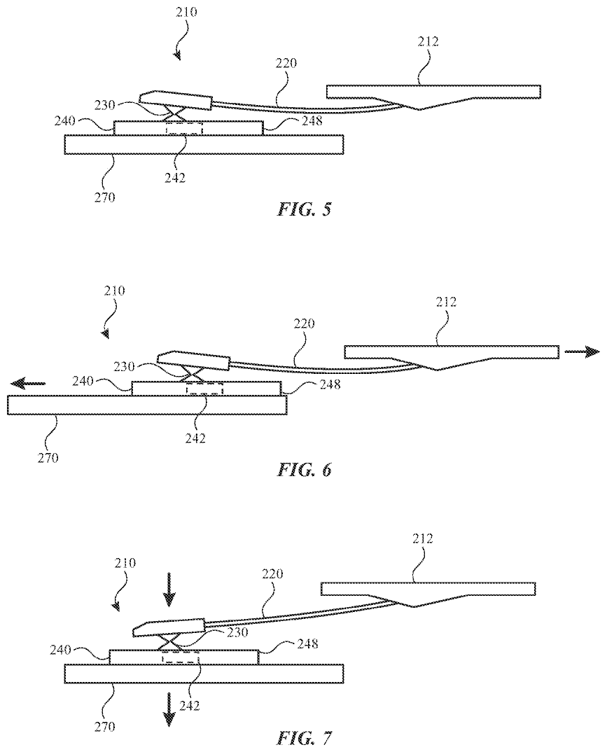

Referring now to FIGS. 5-7, an optical assembly can include or interact with a tracking assembly to monitor and guide movement of the optical device.

The tracking sensor 240 and the scale 270 can, together, form an encoder for encoding the relative positions of the optical assembly and the chassis with respect to each other. Such an encoder can, for example, be a linear encoder. The tracking sensor 240 can read the scale 270 to convert the encoded position into an analog or digital signal, which can then be decoded into position (e.g., relative position) by a digital readout or motion controller. The encoder can be either incremental or absolute. For example, an incremental encoder can produce an index or reference mark pulse providing a datum position along the scale for use at power-up or following a loss of power. This index signal can identify position within one, unique period of the scale. By further example, an absolute encoder can determine its position without movement or needing to find a reference position. Motion can be determined by change in position over time.

The encoder can employ one or more of a variety of sensing technologies, such as optical, magnetic, inductive, resistive, capacitive, eddy current, and/or interferometric sensing, and the like. In some embodiments, an optical encoder can employ shuttering/moiré, diffraction, or holographic principles. For example, light sources used for optical encoders can include infrared LEDs, visible LEDS, miniature light-bulbs, laser diodes, and the like. In some embodiments, a magnetic encoder can employ either active (magnetized) or passive (variable reluctance) scales and position may be sensed using sense-coils, Hall effect, or magnetoresistive readheads. In some embodiments, a capacitive encoder can sense the capacitance between a sensor and scale. In some embodiments, an inductive encoder can sense the inductance between a sensor and scale. In some embodiments, an eddy current encoder can use a scale coded with high and low permeability, non-magnetic materials, where the scale is detected and decoded by monitoring, with the sensor, changes in inductance of an AC circuit that includes an inductive coil sensor.

While a linear encoder is illustrated, it will be understood that a rotational encoded can also provide the function described herein. For example, the scale 270 can rotate with respect to the tracking sensor 240, and the tracking sensor 240 can be biased against the scale 270 in each of a variety of relative rotational orientations thereof. The rotational orientation of the scale 270 can indicate a relative orientation of the optical assembly with respect to the chassis. Additionally or alternatively, the scale 270 can be mounted to a rotating component that corresponds to translation of the optical assembly (e.g., via a rack and pinion arrangement). As such, the rotational orientation of the scale with respect to the tracking sensor 240 can correspond to a position of the optical assembly with respect to the chassis.

In some embodiments, the tracking assembly 210 (e.g., including the tracking sensor 240) can be mounted to the optical assembly and the scale 270 can be mounted to the chassis. Alternatively, in some embodiments, the tracking assembly 210 can be mounted to the chassis and the scale 270 can be mounted to the optical assembly. In either arrangement, the tracking sensor 240 can detect relative movement and/or positioning of the scale 270, thereby providing information sufficient to determine a relative movement and/or positioning of the chassis and the optical assembly.

In some embodiments, as shown in FIGS. 5-7, the tracking assembly 210 can include the tracking sensor 240 (e.g., on the beam 220 and the hinge 230), and the scale 270 can be supported by a different structure. Alternatively, in some embodiments, the tracking assembly 210 can include the scale 270 (e.g., on the beam 220 and the hinge 230), and the tracking sensor 240 can be supported by a different structure. In either arrangement, the tracking sensor 240 can detect relative movement and/or positioning of the scale 270, thereby providing information sufficient to determine a relative movement and/or positioning of the chassis and the optical assembly.

As shown in FIG. 5, the beam 220 can extend from the bracket 212, and the tracking sensor 240 can be coupled to the beam 220 with the hinge 230. The beam 220 can bias the tracking sensor 240 against the scale 270. The hinge 230 can facilitate changes to the rotational orientation of the tracking sensor 240 to accommodate the bias against the scale 270. For example, the tracking sensor 240 can abut the scale 270, and the hinge 230 can allow the tracking sensor 240 to rotationally adjust itself so that its surface conforms to a surface of the scale 270. Accordingly, the reader 242 of the tracking sensor 240 is maintained in a consistent rotational orientation with respect to the scale 270, such as facing a direction to detect the scale 270. As such, the hinge 230 can allow the tracking sensor 240 to conform to a surface against which it is held by a biasing force provided by the beam 220.

As shown in FIG. 6, the tracking assembly 210 can adjust the position and/or orientation of the tracking sensor 240 to accommodate movement across the scale 270. For example, the tracking assembly 210 and the scale 270 can move or be moved with respect to each other when the optical assembly moves with respect to the chassis. Such movement can also have corresponding movement of the tracking sensor 240 with respect to the scale 270. It will be understood that the movement can be relative, such that the movement of either one with respect to the other can be detected. As further shown in FIG. 6, the beam 220 of the tracking assembly 210 can maintain the tracking sensor 240 in a position against the scale 270 and thereby maintain the tracking sensor 240 and/or the reader 242 at a consistent distance with respect to the scale 270. As such movement occurs, the tracking sensor 240 can detect the portion of the scale 270 and thereby determine the relative position of the tracking sensor 240 and the scale 270, as well as the relative position of the chassis and the optical assembly to which the tracking sensor 240 and the scale 270 are mounted.

While movement along an axis (e.g., along the interface between the tracking sensor 240 and the scale 270) is illustrated, it will be understood that movement in multiple axes is contemplated. For example, movement within a plane can be detected by the tracking sensor 240 based on its position with respect to the scale. By further example, the scale 270 can provide reference elements for detection across multiple axes.

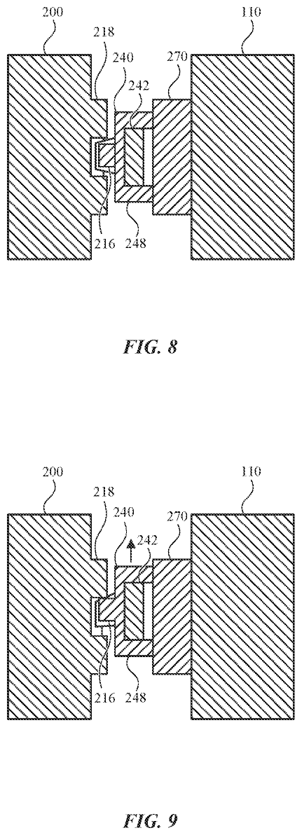

As shown in FIG. 7, the tracking assembly 210 can adjust the position and/or orientation of the tracking sensor 240 to accommodate other types of movement with respect to the scale 270. For example, a distance between the bracket 212 and the scale 270 can change, Paul during operation of the head-mountable device and/or in response to external forces, such as those arising from a drop and/or impact event. Despite such movement, the beam 220 of the tracking assembly 210 can maintain the tracking sensor 240 (e.g., at the frame 248) in a position against the scale 270 and thereby maintain the tracking sensor 240 and/or the reader 242 at a consistent distance with respect to the scale 270. Additionally, the hinge 230 can allow the tracking sensor 240 to rotationally adjust itself so that its surface conforms to a surface of the scale 270, including when the beam 220 changes is orientation to bias the tracking sensor 240 against the scale 270. Accordingly, the hinge 230 can allow the tracking sensor 240 to conform to a surface against which it is held by a biasing force provided by the beam 220.

Additionally, the bias provided by the beam 220 and the rotational adjustability provided by the hinge 230 can allow the sensor 240 to conform to the surface contours of the scale 270, including non-planar shapes. For example, where the scale 270 includes a curved surface, the hinge 230 can allow the tracking sensor 240 to rotationally conform to any portion of the curved surface against which it is held by a biasing force provided by the beam 220.

It will be understood that movement that changes the distance between the tracking assembly 210 and the scale 270 (e.g., with corresponding changes in the distance between the chassis and the optical assembly) need not be detected by the tracking assembly 210. For example, the distance can change while the tracking sensor 240 is maintained in a biased state against the scale 270. Accordingly, the distance between the supporting structures can change while the tracking sensor 240 remains at a consistent distance away from the scale 270 for precise and accurate detections.

Based on the detection's performed by the tracking sensor 240 with respect to the scale 270, the optical assembly can be controllably moved with respect to the chassis. For example, the tracking sensor 240 can verify its relative position with respect to the scale 270, which can be correlated with a relative position of the optical assembly with respect to the chassis. Such a correlation can be made regardless of which one of the chassis and the optical assembly supports the tracking sensor 240 and the scale 270. In some embodiments, the optical assembly can be controllably moved based on detection's performed by a user sensor, such as an eye sensor. For example, the user sensor can detect a position of the eye of a user wearing the head-mountable device. Based on such a detection, the head-mountable device can determine a target location of the optical assembly that would achieve a proper alignment of the optical assembly with respect to the eye of the user. As movement to achieve the target alignment is performed, it can be tracked by the tracking assembly, which detects the relative position of the optical assembly and the chassis. Such tracking can provide feedback that is applied to control and/or refine movement of the optical assembly.

The biasing and compliance provided by the tracking assembly can minimize an air gap between sensor and the scale to improve sensor accuracy, precision, and overall performance. This can also create a deterministic load path between the sensor and scale such that in a drop event, or other external forces applied to the head-mountable device, the sensor and scale are protected against colliding to each other in an uncontrolled manner.

Referring now to FIGS. 8 and 9, the tracking assembly can have a limited range of motion to protect it from excessive forces and/or misalignment with respect to a scale. As shown in FIG. 8, a flange 216 extending from the sensor 240 can be positioned within and/or near one or more stoppers 218. The stoppers 218 can extend from the optical assembly and/or the chassis 110 to one or more sides of the flange 216.

As shown in FIG. 9, as the sensor 240 moves (e.g., upon application of external forces), the flange 216 can come into contact or abut with one of the stoppers 218. The stopper 218 can then arrest further motion of the sensor 240 and thereby limit its motion to within a confined range. Such limits can protect the tracking assembly from excessive motion, such as plastic deformation of the beam and/or other components, which can otherwise result in misalignment of the sensor 240 with respect to the scale 270. For example, while some degree of motion by the tracking sensor 240 can be permitted, the flange 216 can be positioned to abut a stopper 218 when the tracking sensor 240 moves with flexion by the beam that exceeds a threshold thereof. With the protection provided by the interactions between the stoppers 218 and the flange 216, the sensor 240 (e.g., at the frame 248) can be maintained against the scale 270 with the reader 242 at a consistent distance from the scale 270.

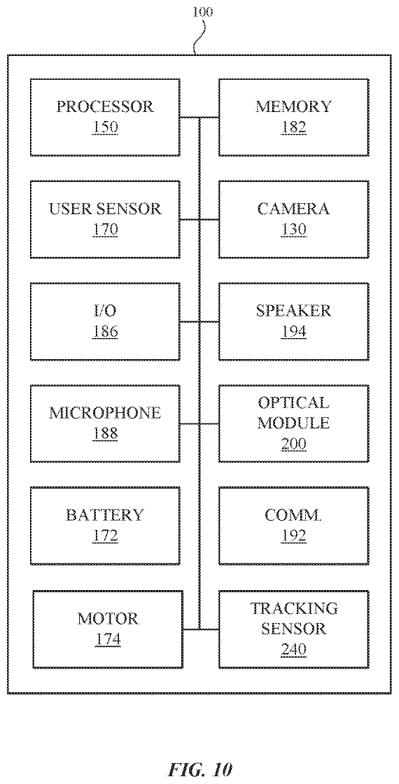

Referring now to FIG. 10, components of the head-mountable device can be operably connected to provide the performance described herein. FIG. 10 shows a simplified block diagram of an illustrative head-mountable device 10 in accordance with one embodiment of the invention. It will be understood that additional components, different components, or fewer components than those illustrated may be utilized within the scope of the subject disclosure.

As shown in FIG. 10, the head-mountable device 10 can include a processor 150 (e.g., control circuity) with one or more processing units that include or are configured to access a memory 182 having instructions stored thereon. The instructions or computer programs may be configured to perform one or more of the operations or functions described with respect to the head-mountable device 10. The processor 150 can be implemented as any electronic device capable of processing, receiving, or transmitting data or instructions. For example, the processor 150 may include one or more of: a microprocessor, a central processing unit (CPU), an application-specific integrated circuit (ASIC), a digital signal processor (DSP), or combinations of such devices. As described herein, the term “processor” is meant to encompass a single processor or processing unit, multiple processors, multiple processing units, or other suitably configured computing element or elements. The processor can be a component of and/or operably connected to the control board and/or another component of the head-mountable device.

The memory 182 can store electronic data that can be used by the head-mountable device 10. For example, the memory 182 can store electrical data or content such as, for example, audio and video files, documents and applications, device settings and user preferences, timing and control signals or data for the various modules, data structures or databases, and so on. The memory 182 can be configured as any type of memory. By way of example only, the memory 182 can be implemented as random access memory, read-only memory, Flash memory, removable memory, or other types of storage elements, or combinations of such devices.

The head-mountable device 10 can include adjustment control components described herein, such as an actuator 174, a motor, and the like for moving components (e.g., optical assemblies 200) to a desired relative position and/or orientation.

The head-mountable device 10 can include one or more user sensors 170, such as the eye sensors of the optical assemblies, as described herein.

The head-mountable device 10 can include an input/output component 186, which can include any suitable component for connecting head-mountable device 10 to other devices. Suitable components can include, for example, audio/video jacks, data connectors, or any additional or alternative input/output components. The input/output component 186 can include buttons, keys, or another feature that can act as a keyboard for operation by the user.

The head-mountable device 10 can include the microphone 188 as described herein. The microphone 188 can be operably connected to the processor 150 for detection of sound levels and communication of detections for further processing, as described further herein.

The head-mountable device 10 can include the speakers 194 as described herein. The speakers 190 can be operably connected to the processor 150 for control of speaker output, including sound levels, as described further herein.

The head-mountable device 10 can include communications circuitry 192 for communicating with one or more servers or other devices using any suitable communications protocol. For example, communications circuitry 192 can support Wi-Fi (e.g., a 802.11 protocol), Ethernet, Bluetooth, high frequency systems (e.g., 900 MHz, 2.4 GHz, and 5.6 GHz communication systems), infrared, TCP/IP (e.g., any of the protocols used in each of the TCP/IP layers), HTTP, BitTorrent, FTP, RTP, RTSP, SSH, any other communications protocol, or any combination thereof. Communications circuitry 192 can also include an antenna for transmitting and receiving electromagnetic signals.

The head-mountable device 10 can include a battery 172, which can charge and/or power components of the head-mountable device 10. The battery 172 can also charge and/or power components connected to the head-mountable device 10 (e.g., the lens assembly 152).

The head-mountable device 10 can include one or more tracking sensors 240, such as the sensors of a tracking assembly that detects a scale across which the tracking sensor 240 can move, as described herein.

Accordingly, embodiments of the present disclosure provide a head-mountable device with an optical assembly that supports a display and is moveable within the head-mountable device. A compliant tracking assembly can be provided to facilitate precision alignment to allow the tracking assembly to operate as an encoder system. For example, the sensor of the tracking assembly can be consistently aligned with a scale so that movement of the optical assembly relative to the chassis can be tracked and controlled accurately and precisely. Such a compliant mechanism can provide protection of the sensor throughout the life of the head-mountable device.

Various examples of aspects of the disclosure are described below as clauses for convenience. These are provided as examples, and do not limit the subject technology.

Clause A: a head-mountable device comprising: a chassis; an optical assembly configured to move relative to the chassis; a scale between the chassis and the optical assembly; a tracking sensor between the chassis and the optical assembly, wherein movement of the optical assembly relative to the chassis causes movement of the scale relative to the tracking sensor, the tracking sensor being biased against the scale and configured to detect a portion of the scale that is adjacent to the tracking sensor; and an actuator configured to control movement of the optical assembly based on a detection by the tracking sensor.

Clause B: a head-mountable device comprising: a chassis; an optical assembly moveably mounted to the chassis; a scale disposed on one of one of the chassis or the optical assembly; and a tracking assembly disposed on the other of the chassis or the optical assembly, the tracking assembly comprising: a beam; a hinge; and a tracking sensor coupled to the beam by the hinge and biased against the scale by the beam.

Clause C: a head-mountable device comprising: a chassis; an optical assembly; a scale between the chassis and the optical assembly; and a tracking assembly between the chassis and the optical assembly, the tracking assembly comprising a tracking sensor and being configured to maintain, throughout a range of motion of the optical assembly relative to the chassis, an orientation of the tracking sensor relative to a scale and a distance between the tracking sensor and the scale.

One or more of the above clauses can include one or more of the features described below. It is noted that any of the following clauses may be combined in any combination with each other, and placed into a respective independent clause, e.g., clause A, B, or C.

Clause 1: the optical assembly comprises: a display; an optical enclosure supporting the display; and a hanger extending from the optical enclosure and defining a channel; and the head-mountable device further comprises a guide rod extending through the channel, wherein the actuator is operable to slide the optical assembly along the guide rod.

Clause 2: an eye sensor configured to detect a location of an eye relative to the optical assembly, wherein the actuator is further configured to control the movement of the optical assembly based on a detection by the tracking sensor.

Clause 3: the tracking sensor is biased against the scale by a beam and coupled to the beam by a hinge.

Clause 4: the tracking sensor is mounted to the optical assembly and the scale is mounted to the chassis.

Clause 5: the tracking sensor is mounted to the chassis and the scale is mounted to the optical assembly.

Clause 6: a camera supported by the chassis and moveable with the optical assembly; a microphone supported by the chassis; a speaker supported by the chassis; and a head engager configured to secure the chassis to a head.

Clause 7: the hinge is a monolithic polymer extending from the beam to the tracking sensor.

Clause 8: the tracking assembly further comprises a bracket for receiving a fastener, wherein the beam, the hinge, and the bracket form a monolithic structure.

Clause 9: the beam comprises carbon fiber or glass fiber.

Clause 10: the tracking assembly further comprises a flex circuit for operably connecting the tracking sensor to a processor of the head-mountable device.

Clause 11: the tracking sensor comprises: a frame coupled to the hinge; and a reader inset within a recess of the frame.

Clause 12: the tracking sensor comprises a flange positioned to abut a stopper of the head-mountable device when the tracking sensor moves with flexion by the beam that exceeds a threshold.

Clause 13: the tracking assembly further comprises a beam configured to bias the tracking sensor against the scale.

Clause 14: the tracking assembly further comprises a hinge coupling the tracking sensor to the beam and allowing the tracking sensor to rotate relative to the beam.

Clause 15: the tracking sensor is an optical sensor, a magnetic sensor, an inductive sensor, a resistive sensor, a capacitive sensor, an eddy current sensor, or an interferometric sensor.

As described herein, aspects of the present technology can include the gathering and use of data. The present disclosure contemplates that in some instances, gathered data can include personal information or other data that uniquely identifies or can be used to locate or contact a specific person. The present disclosure contemplates that the entities responsible for the collection, analysis, disclosure, transfer, storage, or other use of such personal information or other data will comply with well-established privacy practices and/or privacy policies. The present disclosure also contemplates embodiments in which users can selectively block the use of or access to personal information or other data (e.g., managed to minimize risks of unintentional or unauthorized access or use).

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term include, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

In one aspect, a term coupled or the like may refer to being directly coupled. In another aspect, a term coupled or the like may refer to being indirectly coupled.

Terms such as top, bottom, front, rear, side, horizontal, vertical, and the like refer to an arbitrary chassis of reference, rather than to the ordinary gravitational chassis of reference. Thus, such a term may extend upwardly, downwardly, diagonally, or horizontally in a gravitational chassis of reference.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout the disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language of the claims and to encompass all legal equivalents. Notwithstanding, none of the claims are intended to embrace subject matter that fails to satisfy the requirements of the applicable patent law, nor should they be interpreted in such a way.

What is claimed is:

1. A head-mountable device comprising:
a chassis;
an optical assembly configured to move relative to the chassis;
a scale between the chassis and the optical assembly;
a tracking sensor between the chassis and the optical assembly, wherein movement of the optical assembly relative to the chassis causes movement of the scale relative to the tracking sensor, the tracking sensor being biased against the scale and configured to detect a portion of the scale that is adjacent to the tracking sensor; and
an actuator configured to control movement of the optical assembly based on the detected portion of the scale.

2. The head-mountable device of claim 1, wherein:
the optical assembly comprises:
a display;
an optical enclosure supporting the display; and
a hanger extending from the optical enclosure and defining a channel; and
the head-mountable device further comprises a guide rod extending through the channel, wherein the actuator is operable to slide the optical assembly along the guide rod.

3. The head-mountable device of claim 1, further comprising an eye sensor configured to detect a location of an eye relative to the optical assembly, wherein the actuator is further configured to control the movement of the optical assembly based on a detection by the tracking sensor.

4. The head-mountable device of claim 1, wherein the tracking sensor is biased against the scale by a beam and coupled to the beam by a hinge.

5. The head-mountable device of claim 1, wherein the tracking sensor is mounted to the optical assembly and the scale is mounted to the chassis.

6. The head-mountable device of claim 1, wherein the tracking sensor is mounted to the chassis and the scale is mounted to the optical assembly.

7. The head-mountable device of claim 1, further comprising:
a camera supported by the chassis and moveable with the optical assembly;
a microphone supported by the chassis;
a speaker supported by the chassis; and
a head engager configured to secure the chassis to a head.

8. A head-mountable device comprising:
a chassis;
an optical assembly moveably mounted to the chassis;
a scale disposed on one of one of the chassis or the optical assembly; and
a tracking assembly disposed on the other of the chassis or the optical assembly, the tracking assembly comprising:
a beam;
a hinge; and
a tracking sensor coupled to the beam by the hinge and biased against the scale by the beam.

9. The head-mountable device of claim 8, wherein the hinge is a monolithic polymer extending from the beam to the tracking sensor.

10. The head-mountable device of claim 8, wherein the tracking assembly further comprises a bracket for receiving a fastener, wherein the beam, the hinge, and the bracket form a monolithic structure.

11. The head-mountable device of claim 8, wherein at least a portion of the tracking assembly is monolithically formed with the other of the chassis or the optical assembly.

12. The head-mountable device of claim 8, wherein the tracking assembly further comprises a flex circuit for operably connecting the tracking sensor to a processor of the head-mountable device.

13. The head-mountable device of claim 8, wherein the tracking sensor comprises:
a frame coupled to the hinge; and
a reader inset within a recess of the frame.

14. The head-mountable device of claim 8, wherein the tracking sensor comprises a flange positioned to abut a stopper of the head-mountable device when the tracking sensor moves with flexion by the beam that exceeds a threshold.

15. A head-mountable device comprising:
a chassis;
an optical assembly;
a scale between the chassis and the optical assembly; and
a tracking assembly between the chassis and the optical assembly, the tracking assembly comprising a tracking sensor and being configured to maintain, throughout a range of motion of the optical assembly relative to the chassis, an orientation of the tracking sensor relative to the scale and a distance between the tracking sensor and the scale.

16. The head-mountable device of claim 15, wherein the tracking assembly further comprises a beam configured to bias the tracking sensor against the scale.

17. The head-mountable device of claim 16, wherein the tracking assembly further comprises a hinge coupling the tracking sensor to the beam and allowing the tracking sensor to rotate relative to the beam.

18. The head-mountable device of claim 15, wherein the tracking sensor is an optical sensor, a magnetic sensor, an inductive sensor, a resistive sensor, a capacitive sensor, an eddy current sensor, or an interferometric sensor.

19. The head-mountable device of claim 15, wherein the tracking sensor is mounted to the optical assembly and the scale is mounted to the chassis.

20. The head-mountable device of claim 15, wherein the tracking sensor is mounted to the chassis and the scale is mounted to the optical assembly.
